(19) United States
(12) Patent Application Publication
(10) Pub. No.: US 2006/0213539 A1
(43) Pub. Date: Sep. 28, 2006

(54) Method for cleaning thin-film forming apparatus

(76) Inventors: Kazuhide Hasebe, Tokyo-To (JP); Mitsuhiro Okada, Tokyo-To (JP); Takashi Chiba, Tokyo-To (JP); Jun Ogawa, Tokyo-To (JP)

Correspondence Address: SMITH, GAMBRELL & RUSSELL, 1850 M STREET, N.W., SUITE 800, WASHINGTON, DC, 20036, US

(21) Appl. No.: 10/549,851

(22) PCT Filed: Mar. 25, 2004
(86) PCT No.: PCT/JP04/04205

§ 371 Date: Sep. 23, 2005

(30) Foreign Application Priority Data
Mar. 25, 2003 (JP) 2003-083527
Oct. 30, 2003 (JP) 2003-371322

(51) Int. Cl. B08B 9/00; H05H 1/00

(52) U.S. Cl. 134/22.1; 427/535

(57) ABSTRACT

This invention is a cleaning method of a film-forming unit that forms a thin film on an object to be processed by supplying a process gas into a reaction chamber containing the object to be processed, the method comprising a purging step of purging an inside of the reaction chamber by supplying into the reaction chamber a nitrogen-including gas that includes nitrogen and that is capable of being activated. The purging step has a step of nitriding a surface of a member in the reaction chamber by activating the nitrogen-including gas.

### FIELD OF THE INVENTION

This invention relates to a method for cleaning a film-forming unit, in particular to a method for cleaning a film-forming unit by removing reaction products stuck in a discharging system such as a discharging duct in the film-forming unit.

### BACKGROUND ART

In some steps for manufacturing semiconductor device, a thin film is formed on an object to be processed such as a semiconductor wafer by conducting a process such as a CVD (Chemical Vapor Deposition) process. For example, a thermal processing unit shown in FIG. 8 is used for such a film-forming process.

The film-forming process by the thermal processing unit 51 shown in FIG. 8 is conducted as follows. At first, a double-tube-type reactive tube 52 consisting of an inner tube 52a and an outer tube 52b is heated to a predetermined temperature, for example 760° C., by a heater 53. Then, a wafer boat 55 containing a plurality of semiconductor wafers 54 is loaded into the reaction tube 52 (the inner tube 52a). Then, gas in the reaction tube 52 is discharged through a discharging port 56 in order to decompress an inside of the reaction tube 52 to a predetermined pressure, for example 26.5 Pa (0.2 Torr). After the inside of the reaction tube 52 is decompressed to the predetermined pressure, a process gas is supplied from a gas introducing pipe 57 into the inner tube 52a. When the process gas is supplied into the inner tube 52a, the process gas causes a thermal reaction, so that reaction products generated thereby are deposited on surfaces of the plurality of semiconductor wafers 54. Then, a thin film is formed onto each of the plurality of semiconductor wafers 54.

Exhaust gas generated in the film-forming process is discharged through the discharging port 56 and a discharging duct 58, outside the thermal processing unit 51. A trap or a scrubber, not shown, is provided in the discharging duct 58 in order to remove reaction products contained in the exhaust gas.

Herein, the reaction products generated during the film-forming process may be deposited not only on the surfaces of the semiconductor wafers 54, but also on inner surfaces of the thermal processing unit 51, for example on an inner wall of the inner tube 52a. If the film-forming process is continued with the reaction products sticking to them, the reaction products may peel off to become particles. The particles may stick to the semiconductor wafers 54. Thus, a yield of manufactured semiconductor devices may tend to be low.

Thus, in the conventional thermal processing unit, for example, a film-forming process is conducted only such times that no particles are generated. After that, the inside of the thermal processing unit 51 is heated to a predetermined temperature by the heater 53, a mixed gas of a fluorine gas and a halogen-including acid gas (cleaning gas) is supplied into the heated thermal processing unit 51, and the reaction products stuck on the inner surfaces of the thermal processing unit 51 such as the inner wall of reaction tube 52 are removed (dry-etched) (for example, JP Laid-Open publication No. Hei 3-293726).

However, when the cleaning gas is supplied into the thermal processing unit 51, the fluorine contained in the cleaning gas diffuses into a material of the reaction tube 52, for example quartz. Even if a nitrogen gas is supplied into the thermal processing unit 51 after that, the fluorine tends not to be discharged outside the thermal processing unit 41. In addition, if a film-forming process is conducted under a condition wherein the fluorine has diffused into the quartz forming the reaction tube 52, the fluorine may diffuse (outwardly diffuse) from the reaction tube 52 during the film-forming process. In the case, fluorine density in a film formed on a semiconductor wafer 54 may be increased.

In addition, if the fluorine diffuses outward from the reaction tune 52, fluorine impurities (for example, SiF) may be mixed into a film formed on a semiconductor wafer 54. If the fluorine impurities are mixed, a yield of manufactured semiconductor devices may be deteriorated.

In addition, in the conventional thermal processing unit 51, a film-forming process for depositing the reaction products on the surfaces of the semiconductor wafers 54 is repeatedly conducted in the reaction tube 52 maintained at a high temperature and a low pressure. Thus, even if the inside of the unit is periodically cleaned, a minute amount of impurities may be discharged (generated) from the quartz that is a material forming the reaction tube 52. For example, in the quartz that is a material forming the reaction tube 52, a minute amount of metallic contaminant such as copper is included. Then, the metallic contaminant may diffuse outward from the reaction tube 52 during a film-forming process. If the impurities such as the metallic contaminant stick to the semiconductor wafers 54, a yield of manufactured semiconductor devices may be deteriorated.

### SUMMARY OF THE INVENTION

This invention is intended to solve the above problems effectively. An object of this invention is to provide a film-forming unit, a cleaning method of the film-forming unit and a film-forming method, wherein it can be prevented that impurities are mixed into a formed thin film.

In addition, another object of this invention is to provide a film-forming unit, a cleaning method of the film-forming unit and a film-forming method, which can inhibit diffusion of impurities such as fluorine, metallic contaminant and so on.

Furthermore, another object of this invention is to provide a film-forming unit, a cleaning method of the film-forming unit and a film-forming method, which can low inhibit density of impurities such as fluorine, metallic contaminant and so on.

In order to achieve the above objects, a cleaning method of a film-forming unit according to this invention is a cleaning method of a film-forming unit that forms a thin film on an object to be processed by supplying a process gas into a reaction chamber containing the object to be processed, the method comprising a purging step of purging an inside of the reaction chamber by supplying into the reaction chamber a nitrogen-including gas that includes nitrogen and that is capable of being activated, wherein the purging step has a step of nitriding a surface of a member in the reaction chamber by activating the nitrogen-including gas.

According to the invention, a surface of a member in the reaction chamber, for example a surface of a member forming the reaction chamber, is nitrided by the activated nitrogen-including gas. Thus, it becomes difficult for impurities to be discharged from the member in the reaction chamber, so that it can be prevented that the impurities are mixed into a formed thin film.

Alternatively, this invention is a cleaning method of a film-forming unit that forms a thin film on an object to be processed by supplying a process gas into a reaction chamber containing the object to be processed, the method comprising a purging step of purging an inside of the reaction chamber by supplying into the reaction chamber a nitrogen-including gas that includes nitrogen and that is capable of being activated, wherein the purging step has a step of activating the nitrogen-including gas and causing the activated nitrogen-including gas to react with metallic contaminant contained in a member in the reaction chamber so as to remove the metallic contaminant from the member.

According to the feature, the activated nitrogen-including gas reacts with the metallic contaminant contained in a member in the reaction chamber, for example a member forming the reaction chamber, and thus the metallic contaminant is removed from the member. Therefore, an amount of metallic contaminant contained in the member in the reaction chamber may be reduced, and diffusion of the metallic contaminant during the film-forming process may be inhibited. Thus, density of the metallic contaminant in a formed film may be reduced. In addition, it becomes difficult for impurities to be mixed into a formed film.

Alternatively, this invention is a cleaning method of a film-forming unit that forms a thin film on an object to be processed by supplying a process gas into a reaction chamber containing the object to be processed, the method comprising: a deposit-removing step of removing a deposit stuck to an inside of the film-forming unit by supplying into the reaction chamber a cleaning gas that includes fluorine, and a purging step of purging an inside of the reaction chamber by supplying into the reaction chamber a nitrogen-including gas that includes nitrogen and that is capable of being activated, wherein the purging step has a step of activating the nitrogen-including gas and causing the activated nitrogen-including gas to react with the fluorine diffused into a member in the reaction chamber during the deposit-removing step, so as to remove the fluorine from the member.

According to the feature, the activated nitrogen-including gas reacts with the fluorine diffused into a member in the reaction chamber, for example a member forming the reaction chamber, and thus the fluorine is removed from the member. Therefore, an amount of fluorine diffused into the member in the reaction chamber may be reduced, and diffusion of the fluorine during the film-forming process may be inhibited. Thus, density of the fluorine in a formed film may be reduced. In addition, it becomes difficult for impurities to be mixed into a formed film.

Alternatively, this invention is a cleaning method of a film-forming unit that forms a thin film on an object to be processed by supplying a process gas into a reaction chamber containing the object to be processed, the method comprising: a deposit-removing step of removing a deposit stuck to an inside of the film-forming unit by supplying into the reaction chamber a cleaning gas that includes fluorine, and a purging step of purging an inside of the reaction chamber by supplying into the reaction chamber a nitrogen-including gas that includes nitrogen and that is capable of being activated, wherein the purging step has a step of nitriding a surface of a member in the reaction chamber by activating the nitrogen-including gas.

According to the feature, a surface of a member in the reaction chamber, for example a surface of a member forming the reaction chamber, is nitrided by the activated nitrogen-including gas. Thus, it becomes difficult for the fluorine to diffuse (be discharged) from the member in the reaction chamber, so that diffusion of the fluorine during the film-forming process may be inhibited. Thus, density of the fluorine in a formed film may be reduced. In addition, it can be inhibited that impurities are mixed into a formed film.

The nitrogen-including gas is, for example, ammonia, dinitrogen monoxide or nitric oxide.

For example, during the purging step, the inside of the reaction chamber is maintained at a range of 133 Pa to 53.3 kPa.

For example, during the purging step, the nitrogen-including gas is supplied into the reaction chamber heated to a predetermined temperature in order to be activated.

Preferably, during the purging step, the inside of the reaction chamber is heated to a range of 600° C. to 1050° C.

For example, the member in the reaction chamber consists of quartz.

For example, the process gas comprises ammonia and a silicon-including gas, the thin film is a silicon nitride film, and the nitrogen-including gas is an ammonia gas. In the case, for example, the silicon-including gas is dichlorosilane, hexachlorosilane, monosilane, disilane, tetrachlorosilane, trichlorosilane, bis(tert-butylamino)silane or hexaethyl(amino)disilane.

In addition, this invention is a film-forming method comprising: a cleaning step of cleaning a film-forming unit in accordance with a cleaning method of a film-forming unit according to any of the above features, and a film-forming step of heating the inside of the reaction chamber containing the object to be processed to a predetermined temperature, and forming a thin film on the object to be processed by supplying a process gas into the reaction chamber.

According to the invention, it becomes difficult for impurities to be discharged from the member in the reaction chamber, so that it can be inhibited that the impurities are mixed into a formed film.

In addition, this invention is a film-forming unit that forms a thin film on an object to be processed by supplying a process gas into a reaction chamber containing the object to be processed, the film-forming unit comprising: a nitrogen-including-gas supplying unit that supplies into the reaction chamber a nitrogen-including gas that includes nitrogen and that is capable of being activated; an activating unit that activates the nitrogen-including gas; and a nitriding unit that nitrides a surface of a member in the reaction chamber by controlling the activating unit so as to activate the nitrogen-including gas.

According to the invention, a surface of a member in the reaction chamber is nitrided by the activated nitrogen-including gas. Thus, it becomes difficult for impurities to be discharged from the member in the reaction chamber, so that it can be prevented that the impurities are mixed into a formed thin film.

Alternatively, this invention is a film-forming unit that forms a thin film on an object to be processed by supplying a process gas into a reaction chamber containing the object to be processed, the film-forming unit comprising: a nitrogen-including-gas supplying unit that supplies into the reaction chamber a nitrogen-including gas that includes nitrogen and that is capable of being activated; an activating unit that activates the nitrogen-including gas; and a contaminant-removal controlling unit that removes metallic contaminant from a member in the reaction chamber by controlling the activating unit so as to activate the nitrogen-including gas and by causing the activated nitrogen-including gas to react with the metallic contaminant contained in the member.

According to the feature, the nitrogen-including gas activated by the activating unit reacts with the metallic contaminant contained in a member in the reaction chamber, and thus the metallic contaminant is removed from the member. Therefore, an amount of metallic contaminant contained in the member in the reaction chamber may be reduced, and diffusion of the metallic contaminant during the film-forming process may be inhibited. Thus, density of the metallic contaminant in a formed film may be reduced. In addition, it becomes difficult for impurities to be mixed into a formed film.

Alternatively, this invention is a film-forming unit that forms a thin film on an object to be processed by supplying a process gas into a reaction chamber containing the object to be processed, the film-forming unit comprising: a cleaning-gas supplying unit that supplies into the reaction chamber a cleaning gas that includes fluorine; a nitrogen-including-gas supplying unit that supplies into the reaction chamber a nitrogen-including gas that includes nitrogen and that is capable of being activated; an activating unit that activates the nitrogen-including gas; and a fluorine-removal controlling unit that removes fluorine from a member in the reaction chamber by controlling the activating unit so as to activate the nitrogen-including gas and by causing the activated nitrogen-including gas to react with the fluorine diffused into the member.

According to the feature, the nitrogen-including gas activated by the activating unit reacts with the fluorine diffused into a member in the reaction chamber, and thus the fluorine is removed from the member. Therefore, an amount of fluorine diffused into the member in the reaction chamber may be reduced, and diffusion of the fluorine during the film-forming process may be inhibited. Thus, density of the fluorine in a formed film may be reduced. In addition, it becomes difficult for impurities to be mixed into a formed film.

Alternatively, this invention is a film-forming unit that forms a thin film on an object to be processed by supplying a process gas into a reaction chamber containing the object to be processed, the film-forming unit comprising: a cleaning-gas supplying unit that supplies into the reaction chamber a cleaning gas that includes fluorine; a nitrogen-including-gas supplying unit that supplies into the reaction chamber a nitrogen-including gas that includes nitrogen and that is capable of being activated; an activating unit that activates the nitrogen-including gas; and a nitriding unit that nitrides a surface of a member in the reaction chamber by controlling the activating unit so as to activate the nitrogen-including gas.

According to the feature, a surface of a member in the reaction chamber is nitrided by the nitrogen-including gas activated by the activating unit. Thus, it becomes difficult for the fluorine to diffuse (be discharged) from the member in the reaction chamber, so that diffusion of the fluorine during the film-forming process may be inhibited. Thus, density of the fluorine in a formed film may be reduced. In addition, it can be inhibited that impurities are mixed into a formed film.

The nitrogen-including gas is, for example, ammonia, dinitrogen monoxide or nitric oxide.

The activating unit is, for example, a heating unit. Alternatively, the activating unit is a plasma-generating unit. Alternatively, the activating unit is a photodecomposition unit. Alternatively, the activating unit is a catalytic activating unit.

Preferably, the activating unit is a heating unit that heats the inside of the reaction chamber to a range of 600° C. to 1050° C.

In addition, preferably, the film-forming unit further comprises a pressure-adjusting unit that maintains the inside of the reaction chamber at a range of 133 Pa to 53.3 kPa.

### BRIEF DESCRIPTION OF THE DRAWINGS

FIG. 1 is a schematic longitudinal sectional view of a film-forming unit of an embodiment according to the invention;

FIG. 2 is a view showing a recipe for explaining a film-forming method of an embodiment according to the invention;

FIG. 3 is a view showing a recipe for explaining a film-forming method of another embodiment according to the invention;

FIG. 4 is a graph showing a relationship between depth of quartz chip and fluorine density;

FIG. 5 is a graph showing a relationship between depth of quartz chip and secondary ion strength of nitrogen;

FIG. 6 is a graph showing a relationship between purge gases and copper density;

FIG. 7 is a schematic longitudinal sectional view of a film-forming unit of another embodiment according to the invention; and

FIG. 8 is a schematic longitudinal sectional view of a conventional film-forming unit.

### DESCRIPTION OF THE PREFERRED EMBODIMENT

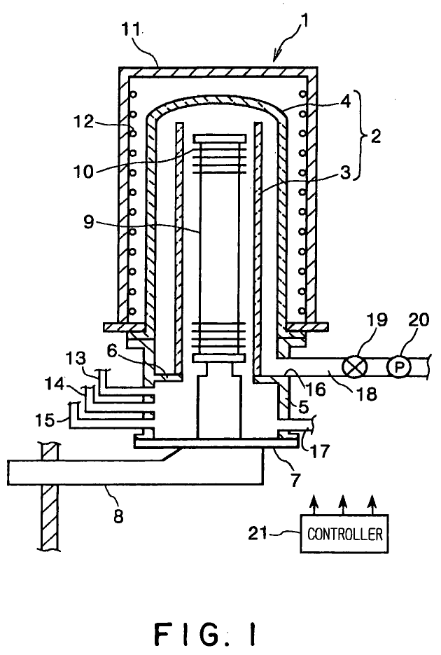

An embodiment of a cleaning method of a film-forming unit according to the invention will now be described in detail with reference to a batch-type vertical thermal processing unit 1 shown in FIG. 1.

As shown in FIG. 1, the thermal processing unit 1 includes a substantially cylindrical reaction tube 2 whose longitudinal axis is arranged in a vertical direction. The reaction tube 2 has a double-tube structure consisting of an inner tube 3 and an outer tube 4 surrounding the inner tube 3. A gap between the inner tube 3 and the outer tube 4 is constant. Only the outer tube 4 has a ceiling. The inner tube 3 and the outer tube 4 are made of a heat-resistant material such as quartz.

A cylindrical manifold 5 made of a stainless steel (SUS) is arranged below the outer tube 4. The manifold 5 is hermetically connected to a lower end of the outer tube 4. The inner tube 3 is supported by a supporting ring 6, which projects from an inside wall of the manifold 5.

A lid 7 is arranged below the manifold 5. The lid 7 is vertically movable by means of a boar elevator 8. When the lid 7 is moved up by the boat elevator 8, a lower end of the manifold 5 is closed.

A wafer boat 9 is placed on the lid 7. The wafer boat 9 is made of for example quartz. The wafer boat 9 can contain a plurality of objects to be processed such as semiconductor wafers 10 in a vertical tier-like manner.

The reaction tube 2 is surrounded by a thermal insulation body 11. Heaters 12, each of which consists of for example a resistor heater, are provided on an inside surface of the insulation body 11. The heaters 12 heat the inside of the reaction tube 2 to a predetermined temperature, so that the semiconductor wafers 10 are heated to a predetermined temperature.

A plurality of process-gas-introducing tubes 13 for introducing a process gas are pierced through a side wall of the manifold 5. Only one process-gas-introducing tube 13 is shown in FIG. 1 for simplification of the drawing. The plurality of process-gas-introducing tubes 13 are provided below the supporting ring 6 and opened to the inside of the inner tube 3.

The plurality of process-gas-introducing tubes 13 are connected to a predetermined process-gas supplying source via mass flow controllers or the like, not shown. If silicon nitride films (SiN films) are formed on the semiconductor wafers 10, they are connected to an ammonia-gas supplying source and a silicon-including-gas supplying source. The silicon-including-gas is, for example, dichlorosilane (SiH₂Cl₂: DCS), hexachlorosilane (Si₂Cl₆), monosilane (SiH₄), disilane (Si₂H₆), tetrachlorosilane (SiCl₄), trichlorosilane (SiHCl₃), bis(tert-butylamino)silane or hexaethyl(amino)disilane. In the present embodiment, they are connected to a DCS-gas supplying source. Thus, an ammonia gas and a DCS gas are introduced into the inner tube 3 through the process-gas-introducing tubes 13 at predetermined flow rates.

A plurality of cleaning-gas-introducing tubes 14 for introducing a cleaning gas are pierced through the side wall of the manifold 5. Only one cleaning-gas-introducing tube 14 is shown in FIG. 1 for simplification of the drawing. The plurality of cleaning-gas-introducing tubes 14 are opened to the inside of the inner tube 3, so that the cleaning gas is adapted to be introduced into the inner tube 3 through the cleaning-gas-introducing tubes 14. In addition, the cleaning-gas-introducing tubes 14 are connected to a predetermined cleaning-gas supplying source such as a fluorine-gas supplying source, a hydrogen-fluoride-gas supplying source and a nitrogen-gas supplying source, not shown, via mass flow controllers or the like, not shown.

A nitrogen-including-gas introducing tube 15 for introducing a nitrogen-including gas is pierced through the side wall of the manifold 5. The nitrogen-including gas includes nitrogen and is capable of being activated. For example, the nitrogen-including gas is ammonia, dinitrogen monoxide (N₂O) or nitric oxide (NO). The nitrogen-including gas can nitride a member in the thermal processing unit 1, for example a member made of quartz.

The nitrogen-including-gas introducing tube 15 is opened to the inside of the inner tube 3. In addition, the nitrogen-including-gas introducing tube 15 is connected to a gas supplying source, not shown, via mass flow controllers or the like, not shown. Thus, the nitrogen-including gas is adapted to be introduced from the gas supplying source not shown into the inner tube 3 through the nitrogen-including-gas introducing tube 15.

A discharging port 16 is also provided at the side wall of the manifold 5. The discharging port 16 is located above the supporting ring 6 and communicates with a space (gap) defined between the inner tube 3 and the outer tube 4. Then, exhaust gas or the like generated in the inner tube 3 is discharged into the discharging port 16 through the space between the inner tube 3 and the outer tube 4. In addition, a purge-gas supplying tube 17 for supplying a nitrogen gas as a purge gas is pierced through the side wall of the manifold 5 below the discharging port 16.

The discharging port 16 is hermetically connected to a discharging duct 18. In the discharging duct 18, a valve 19 and a vacuum pump 20 are provided in turn from an upstream side (discharging port side) of the discharging duct 18. An open level of the discharging duct 18 is adjusted by the valve 19. Thus, a pressure in the reaction tube 2 is controlled to a predetermined pressure. The vacuum pump 20 discharges gas from an inside of the reaction tube 2 via the discharging duct 18 and adjusts the pressure in the reaction tube 2.

In addition, in the discharging duct 18, a trap, a scrubber, and so on, not shown, are also provided. Thus, the exhaust gas discharged from the reaction tube 2 is made harmless and then discharged outside the thermal processing unit 1.

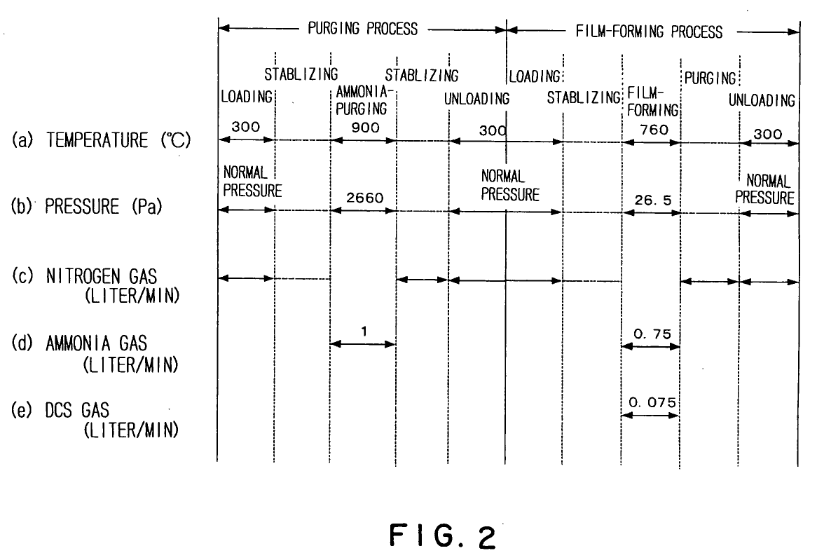

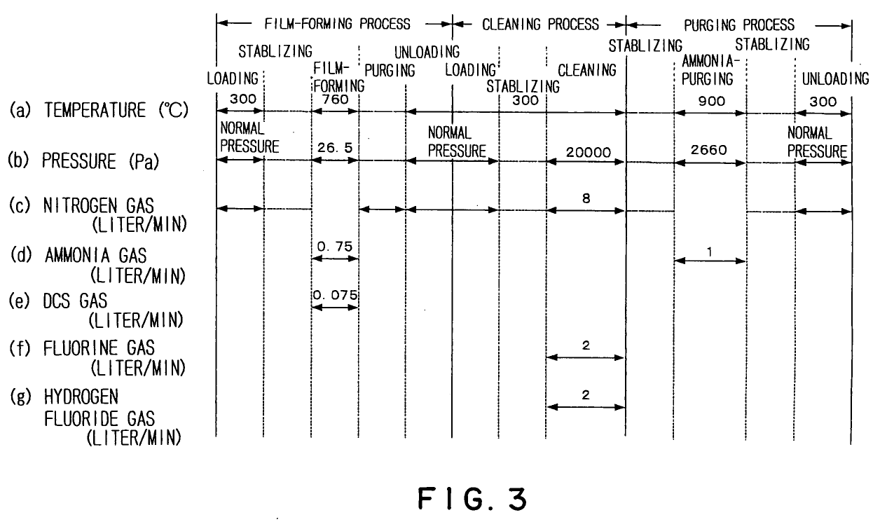

In addition, a controller 21 is connected to the boat elevator 8, the heater 12, the process-gas introducing tubes 13, the cleaning-gas introducing tubes 14, the nitrogen-including-gas introducing tube 15, the purge-gas supplying tube 17, the valve 19 and the vacuum pump 20, respectively. The controller 21 may consist of a microprocessor, a process controller or the like. The controller 21 measures temperatures and pressures at a plurality of positions of the thermal processing unit 1, respectively. Then, the controller 21 outputs controlling signals or the like to each of the above components based on the measured data, in order to control the above components according to a recipe (time sequence) shown in FIG. 2 or 3.

Next, a cleaning method for the thermal processing unit 1 having the above structure, and a film-forming method including the cleaning method for the thermal processing unit 1 are explained. In the present embodiment, an ammonia gas and a DCS gas are introduced into the reaction tube 2 so as to form silicon nitride films on the semiconductor wafers 10. In the following explanation, the controller 21 controls each of components constituting the thermal processing unit 1.

At first, with reference to the recipe shown in FIG. 2, a film-forming method including a purge process that is a cleaning method for the thermal processing unit 1, and a film-forming process for forming silicon nitride films on the semiconductor wafers 10, is explained.

The heater 12 heats the inside of the reaction tube 2 to a predetermined loading temperature, 300° C. in the present embodiment as shown in FIG. 2 (a). As shown in FIG. 2 (c), a predetermined amount of nitrogen gas is supplied into the reaction tube 2 through the purge-gas supplying tube 17, and then the wafer boat 9 not containing the semiconductor wafers 10 is placed on the lid 7. Then, the lid 7 is moved up by the boat elevator 8, and the reaction tube 2 is sealed (loading step).

Next, the gas in the reaction tube 2 is discharged, so that the inside of the reaction tube 2 is set at a predetermined pressure. The pressure in the reaction tube 2 is set at preferably 133 pa (1.0 Torr) to 53.3 kPa (400 Torr). If the pressure is below 133 Pa (1.0 Torr), during an ammonia-purging step described below, it is possible that outward diffusion of impurities (metallic contaminant, fluorine, and so on) in quartz forming the reaction tube 2 and nitridation of the quartz forming the reaction tube 2 are inhibited. More preferably, the pressure in the reaction tube 2 is set at 2660 Pa (20 Torr) to 53.3 kPa (400 Torr). If the pressure is above 2660 Pa (20 Torr), during the ammonia-purging step, the outward diffusion of the impurities and the nitridation of the quartz are promoted. In the present embodiment, as shown in FIG. 2 (b), the pressure is set at 2660 pa (20 Torr).

The inside of the reaction tube 2 is heated to a predetermined temperature by the heater 12. The temperature in the reaction tube 2 is set at preferably 600° C. to 1050° C. If the temperature is below 600° C., during the ammonia-purging step, it is possible that the outward diffusion of the impurities (metallic contaminant, fluorine, and so on) in the quartz forming the reaction tube 2 and the nitridation of the quartz forming the reaction tube 2 are inhibited. On the other hand, if the temperature is above 1050° C., the temperature is beyond a softening point of the quartz forming the reaction tube 2. More preferably, the temperature in the reaction tube 2 is set at 800° C. to 1050° C. If the temperature is above 800° C., during the ammonia-purging step, the outward diffusion of the impurities and the nitridation of the quartz are promoted. In the present embodiment, as shown in FIG. 2 (a), the temperature in the reaction tube 2 is increased to 900° C. The above pressure-reducing and heating operation is continued until the inside of the reaction tube 2 is stabled at a predetermined pressure and a predetermined temperature (stabling step).

When the inside of the reaction tube 2 is stabled at a predetermined pressure and a predetermined temperature, the nitrogen-including gas is introduced into the inner tube 3 through the nitrogen-including-gas introducing tube 15 at a predetermined flow rate. For example, as shown in FIG. 2 (d), an ammonia gas is supplied at a flow rate of 1 liter/min. After a predetermined time has elapsed, the open degree of the valve 19 is controlled, the vacuum pump 20 is operated, and the gas in the reaction tube 2 is discharged. Then, the supply of the ammonia gas and the exhaust of the gas in the reaction tube 2 are repeated plural times (ammonia-purging step).

Herein, in the quartz forming the reaction tube 2 or the like, impurities such as metallic contaminant are included. It is difficult to manufacture the reaction tube 2 without mixing impurities into the quartz forming the reaction tube 2 or the like. Specifically, a metal such as copper may be included depending on the manufacturing step, the manufacturing atmosphere, and so on. If the ammonia gas is supplied into the inner tube 3, the ammonia gas is activated by the heat in the reaction tube 2, and then reacts with the metallic contaminant contained in the quartz forming the reaction tube 2. Thus, it becomes easy for the metallic contaminant to diffuse (outward diffuse) from the quartz forming the reaction tube 2. Thus, the metallic contaminant contained in the quartz forming the reaction tube 2 is reduced, so that diffusion of the metallic contaminant from the reaction tube 2 can be reduced during the film-forming process. As a result, an amount (density) of metallic contaminant contained in the silicon nitride films formed by the film-forming process can be reduced.

In addition, in the quartz forming the reaction tube 2 or the like, fluorine may be mixed (diffused) by a cleaning process described below. In the case, when the ammonia gas is supplied into the inner tube 3, the activated ammonia gas reacts with the fluorine that has been diffused into the quartz, and hence the fluorine may easily diffuse (outward diffuse) from the quartz of the reaction tube 2. Thus, the fluorine diffused into the quartz forming the reaction tube 2 is reduced, so that diffusion of the fluorine from the reaction tube 2 can be reduced during the film-forming process. As a result, an amount (density) of fluorine contained in the silicon nitride films formed by the film-forming process can be reduced. In addition, it can be prevented that fluorine impurities are mixed into the silicon nitride films.

Furthermore, the activated ammonia gas nitrides a surface of the quartz forming the reaction tube 2 or the like. This makes it difficult for the impurities to outward diffuse from the quartz into the reaction tube 2, so that it can be prevented that the impurities such as the metallic contaminant are mixed into the silicon nitride films formed by the film-forming process. In particular, when a nitride film is formed by nitriding a surface of the quartz forming the reaction tube 2 or the like by using radicals such as N* and NH* of the ammonia gas, it becomes difficult for the impurities such as the metallic contaminant to be discharged from the quartz into the reaction tube 2. Thus, it is more preferable to form a nitride film on a surface of the quartz forming the reaction tube 2 or the like by the activated ammonia gas.

Next, the open degree of the valve 19 is controlled, the vacuum pump 20 is operated, and the gas in the reaction tube 2 is discharged. On the other hand, as shown in FIG. 2 (c), a predetermined amount of nitrogen gas is supplied from the purge-gas supplying tube 17. The gas in the reaction tube 2 is discharged to the discharging duct 18. In addition, the heater 12 adjusts the inside of the reaction tube 2 at a predetermined temperature, for example 300° C. as shown in FIG. 2(a). Then, as shown in FIG. 2 (b), the pressure in the reaction tube 2 is returned back to a normal pressure (stabling step). Then, the lid 7 is moved down by the boat elevator 8 and unloaded (unloading step).

After the thermal processing unit 1 is cleaned as described above, a film-forming process that forms silicon nitride films on the semiconductor wafers 10 is carried out.

At first, the heater 12 heats the inside of the reaction tube 2 at a predetermined loading temperature, for example 300° C. as shown in FIG. 2(a). In addition, in a state wherein the lid 7 is located at a lower position by the boat elevator 8, the wafer boat 9 containing the semiconductor wafers 10 is placed on the lid 7. Then, as shown in FIG. 2 (c), a predetermined amount of nitrogen gas is supplied from the purge-gas supplying tube 17 into the reaction tube 2. Then, the lid 7 is moved up by the boat elevator 8, and the wafer boat 9 is loaded into the reaction tube 2. Thus, the semiconductor wafers 10 are contained in the inner tube 3 of the reaction tube 2, and the reaction tube 2 is hermetically closed (loading step).

After the reaction tube 2 is hermetically closed, the open level of the valve 19 is controlled and the vacuum pump 20 is operated. Thus, the gas in the reaction tube 2 is discharged and the pressure in the reaction tube 2 is decompressed to a predetermined pressure, for example 26.5 Pa (0.2 Torr) as shown in FIG. 2(b). In addition, the heater 12 heats the inside of the reaction tube 2 to a predetermined temperature, for example 760° C. as shown in FIG. 2(a). The above pressure-reducing and heating operation is continued until the inside of the reaction tube 2 is stabled at a predetermined pressure and a predetermined temperature (stabling step).

When the inside of the reaction tube 2 is stabled at a predetermined pressure and a predetermined temperature, the supply of the nitrogen gas from the purge-gas supplying tube 17 is stopped. Then, the ammonia gas as a process gas is supplied from the process-gas introducing tubes 13 into the inner tube 3, for example at a flow rate of 0.75 liter/min as shown in FIG. 2 (d), and the DCS gas as a process gas is also supplied from the process-gas introducing tubes 13 into the inner tube 3, for example at a flow rate of 0.075 liter/min as shown in FIG. 2 (e).

When the ammonia gas and the DCS gas are introduced, a thermal decomposition reaction is caused by the heat in the reaction tube 2, so that silicon nitride is deposited on surfaces of the semiconductor wafers 10. Thus, silicon nitride films are formed on the surfaces of the semiconductor wafers 10 (film-forming step).

When silicon nitride films having a predetermined thickness are formed on the surfaces of the semiconductor wafers 10, the supply of the ammonia gas and the DCS gas from the process-gas introducing tubes 13 is stopped. Then, the open level of the valve 19 is controlled, the vacuum pump 20 is operated, and the gas in the reaction tube 2 is discharged. On the other hand, as shown in FIG. 2 (c), a predetermined amount of nitrogen gas is supplied from the purge-gas supplying tube 17. The gas in the reaction tube 2 is discharged to the discharging duct 18 (purging step). In order to surely discharge the gas in the reaction tube 2, it is preferable to repeat the gas-discharging step of the reaction tube 2 and the supplying step of the nitrogen gas plural times.

Finally, as shown in FIG. 2 (c), a predetermined amount of the nitrogen gas is supplied through the purge-gas supplying tube 17, and the pressure in the reaction tube 2 is returned back to a normal pressure. Then, the lid 7 is moved down by the boat elevator 8 so that the wafer boat 9 (semiconductor wafers 10) is unloaded from the reaction tube 2 (unloading step).

The above film-forming process may be repeated plural times after the purging process. For example, after the thermal processing unit 1 is cleaned by the purging process, the film-forming process may be repeated a predetermined number of times. Thus, the silicon nitride films can be formed on the semiconductor wafers 10 continuously. In addition, when the purging process and the film-forming process are always alternately conducted, mixing of the metallic contaminant and the fluorine into the formed silicon nitride films can be reduced.

According to the above film-forming method, the amount of the metallic contaminant and/or the fluorine in the quartz forming the reaction tube 2 can be reduced, so that the diffusion of the metallic contaminant or the like from the reaction tube 2 during the film-forming process can be reduced. As a result, the mixing of the impurities into the silicon nitride films formed by the film-forming process can be reduced, so that the density of the impurities in the silicon nitride films can be reduced.

In addition, when a nitride film is formed by nitriding a surface of the quartz forming the reaction tube 2 or the like by using radicals such as N* and NH* of the activated ammonia gas, it becomes more difficult for the impurities to diffuse (outward diffuse) from the quartz into the reaction tube 2. As a result, the mixing of the impurities into the silicon nitride films formed by the film-forming process can be reduced, so that the density of the impurities in the silicon nitride films can be reduced.

Next, with reference to a recipe shown in FIG. 3, a film-forming method including a film-forming process, a cleaning process for removing the silicon nitride stuck to the inner surfaces of the thermal processing unit 1, and a purging process is explained. The cleaning process and the purging process correspond to a cleaning method for a film-forming unit according to the invention.

At first, the heater 12 heats the inside of the reaction tube 2 at a predetermined loading temperature, for example 300° C. as shown in FIG. 3 (a). In addition, in a state wherein the lid 7 is located at a lower position by the boat elevator 8, the wafer boat 9 containing the semiconductor wafers 10 is placed on the lid 7. Then, as shown in FIG. 3 (c), a predetermined amount of nitrogen gas is supplied from the purge-gas supplying tube 17 into the reaction tube 2. Then, the lid 7 is moved up by the boat elevator 8, and the wafer boat 9 is loaded into the reaction tube 2. Thus, the semiconductor wafers 10 are contained in the inner tube 3 of the reaction tube 2, and the reaction tube 2 is hermetically closed (loading step).

After the reaction tube 2 is hermetically closed, the open level of the valve 19 is controlled and the vacuum pump 20 is operated. Thus, the gas in the reaction tube 2 is discharged and the pressure in the reaction tube 2 is decompressed to a predetermined pressure, for example 26.5 Pa (0.2 Torr) as shown in FIG. 3 (b). In addition, the heater 12 heats the inside of the reaction tube 2 to a predetermined temperature, for example 760° C. as shown in FIG. 3 (a). The above pressure-reducing and heating operation is continued until the inside of the reaction tube 2 is stabled at a predetermined pressure and a predetermined temperature (stabling step).

When the inside of the reaction tube 2 is stabled at a predetermined pressure and a predetermined temperature, the supply of the nitrogen gas from the purge-gas supplying tube 17 is stopped. Then, the ammonia gas as a process gas is supplied from the process-gas introducing tubes 13 into the inner tube 3, for example at a flow rate of 0.75 liter/min as shown in FIG. 3 (d), and the DCS gas as a process gas is also supplied from the process-gas introducing tubes 13 into the inner tube 3, for example at a flow rate of 0.075 liter/min as shown in FIG. 3 (e).

When the ammonia gas and the DCS gas are introduced, a thermal decomposition reaction is caused by the heat in the reaction tube 2, so that silicon nitride is deposited on surfaces of the semiconductor wafers 10. Thus, silicon nitride films are formed on the surfaces of the semiconductor wafers 10 (film-forming step).

When silicon nitride films having a predetermined thickness are formed on the surfaces of the semiconductor wafers 10, the supply of the ammonia gas and the DCS gas from the process-gas introducing tubes 13 is stopped. Then, the open level of the valve 19 is controlled, the vacuum pump 20 is operated, and the gas in the reaction tube 2 is discharged. On the other hand, as shown in FIG. 3 (c), a predetermined amount of nitrogen gas is supplied from the purge-gas supplying tube 17. The gas in the reaction tube 2 is discharged to the discharging duct 18 (purging step).

Finally, as shown in FIG. 3 (c), a predetermined amount of the nitrogen gas is supplied through the purge-gas supplying tube 17, and the pressure in the reaction tube 2 is returned back to a normal pressure. Then, the lid 7 is moved down by the boat elevator 8 so that the wafer boat 9 (semiconductor wafers 10) is unloaded from the reaction tube 2 (unloading step).

After the above film-forming process is conducted plural times, the silicon nitride formed during the film-forming process may be deposited on (stuck to) not only the surfaces of the semiconductor wafers 10, but also the inner surfaces of the thermal processing unit 1 (film-forming unit) such as the inner wall of the inner tube 3. Thus, after the film-forming process is conducted a predetermined number of times, a cleaning process that removes the silicon nitride stuck to the inside of the thermal processing unit 1 is conducted. During the cleaning process, a gas consisting of: a cleaning gas including a fluorine gas (F₂) such as a fluorine gas itself, a hydrogen fluoride gas (HF), and a nitrogen gas (N₂) as a diluent is supplied into the thermal processing unit 1 (reaction tube 2). The cleaning process of the thermal processing unit 1 is explained as follows.

At first, as shown in FIG. 3 (c), a predetermined amount of nitrogen gas is supplied into the reaction tube 2 through the purge-gas supplying tube 17, and then the wafer boat 9 not containing the semiconductor wafers 10 is placed on the lid 7. Then, the lid 7 is moved up by the boat elevator 8, and the reaction tube 2 is sealed (loading step).

Next, the gas in the reaction tube 2 is discharged, so that the inside of the reaction tube 2 is maintained at a predetermined pressure, for example 20000 Pa (150 Torr) as shown in FIG. 3 (b). In addition, the heater 12 heats (maintains) the inside of the reaction tube 2 at a predetermined temperature, for example 300° C. as shown in FIG. 3 (a). The above pressure-reducing and heating operation is continued until the inside of the reaction tube 2 is stabled at a predetermined pressure and a predetermined temperature (stabling step).

When the inside of the reaction tube 2 is stabled at a predetermined pressure and a predetermined temperature, the cleaning gas is introduced into the inner tube 3 through the cleaning-gas introducing tubes 14 at a predetermined flow rate. For example, a fluorine gas is supplied at a flow rate of 2 liter/min as shown in FIG. 3 (f), a hydrogen-fluoride gas is supplied at a flow rate of 2 liter/min as shown in FIG. 3 (g), and a nitrogen gas is supplied at a flow rate of 8 liter/min as shown in FIG. 3 (c). The introduced cleaning gas is heated in the inner tube 3, and is discharged from the inner tube 3 to the discharging duct 18 through the space formed between the inner tube 3 and the outer tube 4. During that discharge, the cleaning gas comes in contact with the silicon nitride stuck to the inner surfaces of the thermal processing unit 1, such as the inner wall and the outer wall of the inner tube 3, the inner wall of the outer tube 4, the inner wall of the discharging duct 18, and the wafer boat 9, in order to etch the silicon nitride. Thus, the silicon nitride stuck to the inner surfaces of the thermal processing unit 1 is removed (cleaning step).

Herein, when the fluorine gas is supplied into the reaction tube 2 during the cleaning step, the fluorine gas may diffuse into the quartz forming the reaction tube 2, for example. If a film-forming process is conducted under a state wherein the fluorine has been diffused into the quartz of the reaction tube 2, the fluorine may diffuse (outward diffuse) from the reaction tube 2 during the film-forming process, so that fluorine density in the silicon nitride film formed on the semiconductor wafers 10 may be increased. In addition, as the fluorine diffuses outward from the reaction tube 2, it is possible that fluorine impurities (for example, SiF) are mixed into the thin films formed on the semiconductor wafers 10. Thus, after the cleaning process is conducted, a purging process that purges the inside of the thermal processing unit 1 is conducted. The purging process is explained as follows.

At first, the supply of the cleaning gas from the cleaning-gas supplying tubes 14 is stopped. Then, a predetermined amount of nitrogen gas is supplied from the purge-gas supplying tube 17, and the gas in the reaction tube 2 is discharged. On the other hand, the pressure in the reaction tube 2 is set at a predetermined pressure, for example 133 pa (1.0 Torr) to 53.3 kPa (400 Torr) as described above. In the present embodiment, the pressure is set at 2660 Pa (20 Torr), as shown in FIG. 3 (b). In addition, the inside of the reaction tube 2 is set at a predetermined temperature, for example 600° C. to 1050° C. as described above, by the heater 12. In the present embodiment, the temperature is increased to 900° C., as shown in FIG. 3 (a). The above pressure-reducing and heating operation is continued until the inside of the reaction tube 2 is stabled at a predetermined pressure and a predetermined temperature (stabling step).

When the inside of the reaction tube 2 is stabled at a predetermined pressure and a predetermined temperature, the nitrogen-including gas is introduced into the inner tube 3 through the nitrogen-including-gas introducing tube 15 at a predetermined flow rate. For example, as shown in FIG. 3 (d), an ammonia gas is supplied at a flow rate of 1 liter/min. After a predetermined time has elapsed, the open degree of the valve 19 is controlled, the vacuum pump 20 is operated, and the gas in the reaction tube 2 is discharged. Then, the supply of the ammonia gas and the exhaust of the gas in the reaction tube 2 are repeated plural times (ammonia-purging step).

When the ammonia gas is supplied into the inner tube 3, the ammonia gas is activated (excited) by the heat in the reaction tube 2. The activated ammonia easily reacts with the fluorine that has been diffused into the quartz forming the reaction tune 2, in order to generate ammonium fluoride (NH₄F), for exampl. Thus, the fluorine is discharged out from the reaction tube 2. Thus, an amount of the fluorine that has been diffuse into the quartz forming the reaction tube 2 is reduced, so that diffusion of the fluorine from the reaction tube 2 during the film-forming process can be reduced. As a result, fluorine density in the silicon nitride film formed by the film-forming process can be reduced. In addition, it can be inhibited that fluorine impurities such as SiF are mixed into the silicon nitride film.

In addition, the activated ammonia may react with metallic contaminant contained in the quartz forming the reaction tube 2. Thus, it becomes easier for the metallic contaminant to diffuse (outward diffuse) from the quarts of the reaction tube 2. Thus, the metallic contaminant contained in the quartz forming the reaction tube 2 is reduced, so that diffusion of the metallic contaminant from the reaction tube 2 during the film-forming process can be reduced. As a result, an amount (density) of the metallic contaminant in the silicon nitride film formed by the film-forming process can be reduced.

In addition, the activated ammonia may nitride a surface of the quartz forming the reaction tube 2 or the like. Thus, it becomes difficult for the fluorine in the quartz to diffuse from the reaction tube 2, so that the diffusion of the fluorine from the reaction tube 2 during the film-forming process can be reduced. As a result, fluorine density in the silicon nitride film formed by the film-forming process can be reduced. In addition, it can be inhibited that impurities are mixed into the silicon nitride film. In particular, when a nitride film is formed by nitriding a surface of the quartz forming the reaction tube 2 or the like by using radicals such as N* and NH* of the ammonia gas, it becomes difficult for the impurities to diffuse from the quartz into the reaction tube 2. Thus, it is more preferable to form a nitride film on a surface of the quartz forming the reaction tube 2 or the like by the activated ammonia gas.

Next, the open degree of the valve 19 is controlled, the vacuum pump 20 is operated, and the gas in the reaction tube 2 is discharged. On the other hand, a predetermined amount of nitrogen gas is supplied from the purge-gas supplying tube 17. The gas in the reaction tube 2 is discharged to the discharging duct 18. In addition, the heater 12 adjusts the inside of the reaction tube 2 at a predetermined temperature, for example 300° C. as shown in FIG. 3 (a). Then, as shown in FIG. 3 (b), the pressure in the reaction tube 2 is returned back to a normal pressure (stabling step). Then, the lid 7 is moved down by the boat elevator 8 and unloaded (unloading step). Then, the wafer boat 9 containing the semiconductor wafers 10 is placed on the lid 7. Thus, a film-forming process for forming silicon nitride films on the semiconductor wafers 10 may be conducted.

As described above, by repeating the cleaning method for the film-forming unit including the cleaning process and the purging process after a predetermined times of the film-forming processes, silicon nitride films can be formed on the semiconductor wafers 10 continuously. Herein, after each film-forming process, the cleaning process and the purging process may be conducted. In the case, the inside of the furnace (the inside of the reaction tube 2) is cleaned each time, so that mixing of the metallic contaminant and/or the fluorine into the formed silicon nitride films may be reduced.

In the above film-forming method, the amount of fluorine, which has been diffused into the quartz forming the reaction tube 2 during the cleaning process, can be reduced, so that the diffusion of the fluorine or the like from the reaction tube 2 during the film-forming process can be reduced. Thus, the fluorine density in the silicon nitride film formed by the film-forming process can be reduced. In addition, it can be inhibited that fluorine impurities such as SiF are mixed into the silicon nitride film. That is, the mixing of the impurities into the silicon nitride films formed by the film-forming process can be reduced, so that the density of the impurities in the silicon nitride films can be reduced.

In addition, when a nitride film is formed by nitriding a surface of the quartz forming the reaction tube 2 or the like by using radicals such as N* and NH* of the activated ammonia gas, it becomes more difficult for the impurities to diffuse (outward diffuse) from the quartz into the reaction tube 2. As a result, the mixing of the impurities into the silicon nitride films formed by the film-forming process can be reduced, so that the density of the impurities in the silicon nitride films can be reduced.

Next, in order to confirm an effect of the present embodiment, after a quartz chip was contained in the thermal processing unit 1 (reaction tube 2) and a cleaning process using a cleaning gas including a fluorine gas was conducted, a conventional nitrogen-purging (N₂ purge) using a nitrogen gas was conducted or an ammonia-purging (NH₃ purge) using an ammonia gas according to the invention was conducted, and then fluorine density in a depth direction of the quartz chip was measured. In addition, secondary ion strength of nitrogen was measured by a secondary ion mass spectrometry (SIMS).

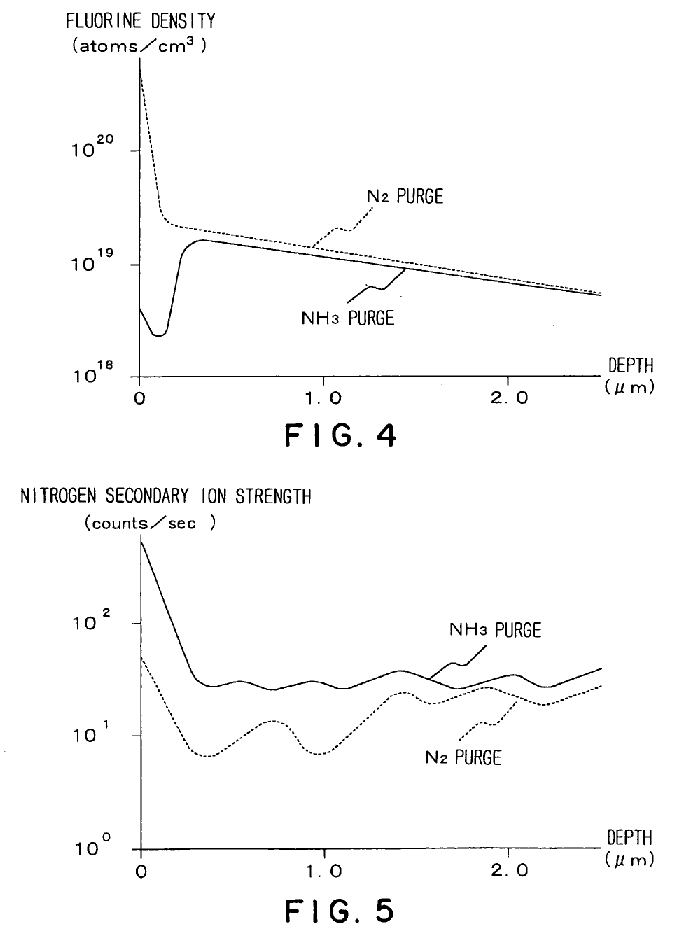

Herein, the cleaning process and the ammonia-purging were conducted in accordance with the above embodiment. The nitrogen-purging was conducted under the same conditions as the ammonia-purging except that the nitrogen gas was used as a purge gas. FIG. 4 shows a relationship between depth of quartz chip and fluorine density. FIG. 5 shows a relationship between depth of quartz chip and secondary ion strength of nitrogen.

As shown in FIG. 4, it was confirmed that the amount of fluorine diffused into the quartz chip may be reduced (inhibited) by conducting the ammonia-purging. In particular, it was confirmed that the amount of fluorine may be greatly reduced (inhibited) in the vicinity of the surface of the quartz chip. The reason may be thought because the activated ammonia reacts with the fluorine diffused in the vicinity of the surface of the quartz chip and the fluorine is discharged.

In addition, as shown in FIG. 5, it was confirmed that the secondary ion strength of nitrogen may be enhanced by conducting the ammonia-purging. In particular, it was confirmed that the secondary ion strength of nitrogen may be greatly enhanced in the vicinity of the surface of the quartz chip. That is, the vicinity of the surface of the quartz chip is nitrided by the ammonia-purging.

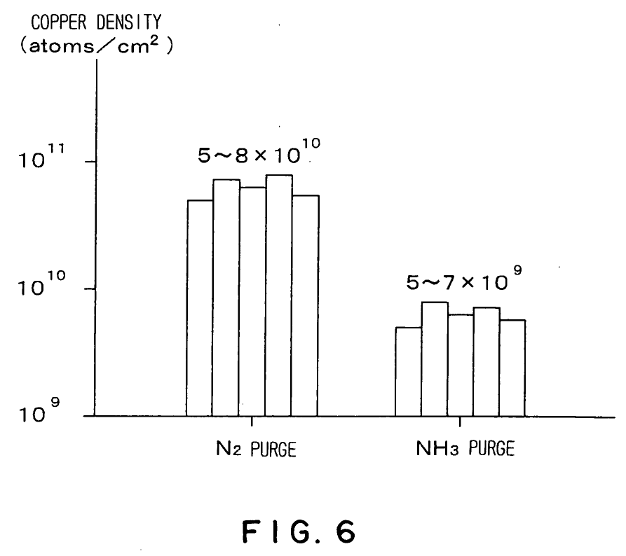

Next, in order to confirm an effect of the present embodiment, after a film-forming process and a cleaning process were conducted, wafers were loaded into the reaction tube 2 that has been subjected to a conventional nitrogen-purging (N₂ purge) using a nitrogen gas or an ammonia-purging (NH₃ purge) using an ammonia gas according to the invention, the inside of the reaction tube 2 was heated to 800° C. so as to heat the wafers, the heated wafers were taken out, and copper density on a wafer surface was measured. The result is shown in FIG. 6. As shown in FIG. 6, the measurement of the copper density was conducted for five predetermined points on the wafer surface in accordance with a total reflection X-ray fluorescence analyzing method. In addition, in the ammonia-purging step, the temperature in the reaction tube 2 was 950° C., the pressure therein was 15960 Pa (120 Torr), and the ammonia gas was supplied into the reaction tube 2 at a flow rate of 2 liter/min under the above temperature and the above pressure.

As shown in FIG. 6, it was confirmed that the copper density on the wafer surface may be reduced to 1/10 by conducting the ammonia-purging. The reason may be thought because the activated ammonia reacts with the copper existing in the quartz (reaction tube 2, wafer boat 9, or the like) so as to discharge the copper from the quartz. Thus, it becomes difficult for the copper to be discharged from the quartz during the film-forming process, so that diffusion of the copper during the film-forming process can be inhibited. In addition, the same density measurements for chrome (Cr) and nickel (Ni) were conducted, and thus it was confirmed that chrome density and nickel density in the silicon nitride film may be reduced by conducting the ammonia-purging.

As described above, according to the embodiment, since the amounts of the fluorine and the metallic contaminant in the reaction tube 2 may be reduced by the ammonia-purging, the diffusion of the fluorine and the metallic contaminant from the reaction tube 2 during the film-forming process may be reduced. As a result, fluorine density in the silicon nitride film formed by the film-forming process may be reduced. In addition, it can be inhibited that the impurities such as the metallic contaminant are mixed into the silicon nitride film.

In addition, according to the embodiment, since the surface of the quartz forming the reaction tube 2 is nitrided by the ammonia-purging, the diffusion of the fluorine and the metallic contaminant from the reaction tube 2 during the film-forming process can be reduced. As a result, fluorine density in the silicon nitride film formed by the film-forming process may be reduced. In addition, it can be inhibited that the impurities such as the metallic contaminant are mixed into the silicon nitride film.

In addition, the invention is not limited to the above embodiment, but may be variously modified and developed.

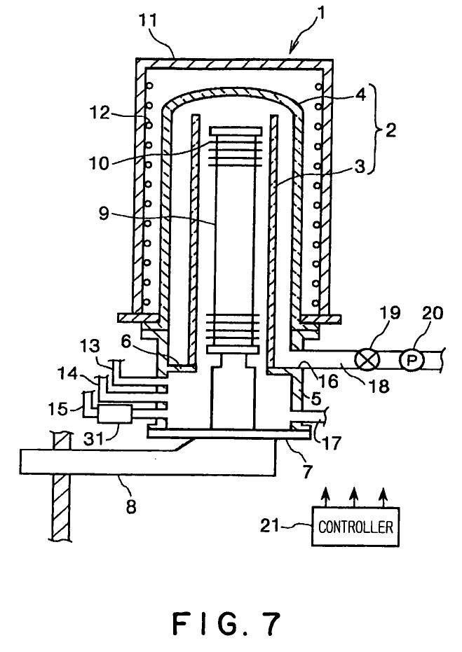

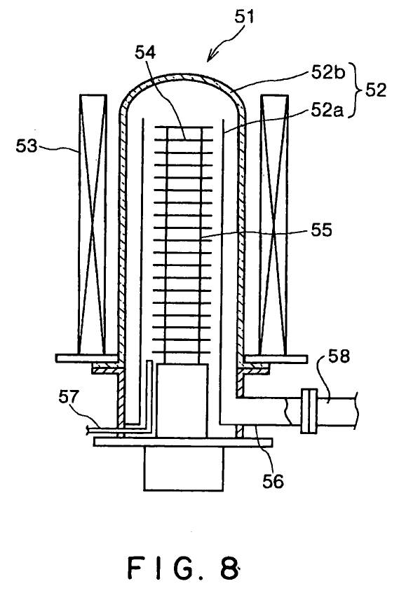

In the above embodiment, a nitrogen-including gas not activated is supplied into the reaction tube 2 heated to a predetermined temperature (900° C.) to be activated. However, for example as shown in FIG. 7, an activating unit 31 may be provided in the nitrogen-including gas introducing tube 15, and a nitrogen-including gas that has been activated may be supplied into the reaction tube 2. In the case, even if the temperature in the reaction tube 2 is below 600° C. during the ammonia-purging step, outward diffusion of the impurities in the quartz and nitridation of the quartz may be satisfactorily conducted. That is, lowering of the temperature of the ammonia purging may be achieved. As an activating unit 31, a heating unit, a plasma-generating unit, a photodecomposition unit, a catalytic activating unit and so on may be used.

In the above embodiment, the ammonia gas is used as a nitrogen-including gas. However, the nitrogen-including gas may be any gas that includes nitrogen and that is capable of being activated. For example, the nitrogen-including gas may be dinitrogen monoxide or nitric oxide. In addition, the cleaning gas may be any gas that includes fluorine. For example, the cleaning gas may consist of a gas including fluorine and chlorine such as ClF₃.

In the above embodiment, the reaction tube 2 or the like is made of quartz. However, the material forming the reaction tube 2 or the like is not limited to quartz. For example, the invention is effective for any material into which fluorine can diffuse, such as any SiC material. Herein, since it is requested that the reaction tube 2 or the like has good heat resistance, it is preferable that the material is superior in heat resistance.

In the above embodiment, the silicon nitride films are formed on the semiconductor wafers 10. However, this invention is also effective for a film-forming unit that forms titanium nitride films on the semiconductor wafers 10.

In the above embodiment, the ammonia purge is conducted under the condition wherein the temperature in the reaction tube 2 is set at 900° C. and the pressure therein is set at 2660 Pa (20 Torr). However, the temperature and the pressure in the reaction tube 2 are not limited thereto. For example, the temperature in the reaction tube 2 may be set at 950° C. and the pressure therein may be set at 15960 Pa (120 Torr). If the temperature and the pressure in the reaction tube 2 are increased like this, the surface of the quartz of the reaction tube 2 is nitrided more, so that the diffusion of the fluorine or the like from the reaction tube 2 during the film-forming process can be inhibited more. In addition, frequency of the cleaning process may be one time for several film-forming processes or one time for each film-forming process.

In the above embodiment, the batch-type of vertical thermal processing unit having a double-tube structure is explained wherein the reaction tube 2 is formed by the inner tube 3 and the outer tube 4. However, the invention is not limited thereto. For example, the invention is allocable to any batch-type of thermal processing unit having a single-tube structure not including the inner tube 3. In addition, the object to be processed is not limited to the semiconductor wafer 10, but may be a glass substrate for an LCD.

1. A cleaning method of a film-forming unit that forms a thin film on an object to be processed by supplying a process gas into a reaction chamber containing the object to be processed, the method comprising;
a purging step of purging an inside of the reaction chamber by supplying into the reaction chamber a nitrogen-including gas that includes nitrogen and that is capable of being activated,
wherein the purging step has a step of nitriding a surface of a member in the reaction chamber by activating the nitrogen-including gas.

2. A cleaning method of a film-forming unit that forms a thin film on an object to be processed by supplying a process gas into a reaction chamber containing the object to be processed, the method comprising;
a purging step of purging an inside of the reaction chamber by supplying into the reaction chamber a nitrogen-including gas that includes nitrogen and that is capable of being activated,
wherein the purging step has a step of activating the nitrogen-including gas and causing the activated nitrogen-including gas to react with metallic contaminant contained in a member in the reaction chamber so as to remove the metallic contaminant from the member.

3. A cleaning method of a film-forming unit that forms a thin film on an object to be processed by supplying a process gas into a reaction chamber containing the object to be processed, the method comprising;
a deposit-removing step of removing a deposit stuck to an inside of the film-forming unit by supplying into the reaction chamber a cleaning gas that includes fluorine, and
a purging step of purging an inside of the reaction chamber by supplying into the reaction chamber a nitrogen-including gas that includes nitrogen and that is capable of being activated,
wherein the purging step has a step of activating the nitrogen-including gas and causing the activated nitrogen-including gas to react with the fluorine diffused into a member in the reaction chamber during the deposit-removing step, so as to remove the fluorine from the member.

4. A cleaning method of a film-forming unit that forms a thin film on an object to be processed by supplying a process gas into a reaction chamber containing the object to be processed, the method comprising;
a deposit-removing step of removing a deposit stuck to an inside of the film-forming unit by supplying into the reaction chamber a cleaning gas that includes fluorine, and
a purging step of purging an inside of the reaction chamber by supplying into the reaction chamber a nitrogen-including gas that includes nitrogen and that is capable of being activated,
wherein the purging step has a step of nitriding a surface of a member in the reaction chamber by activating the nitrogen-including gas.

5. A cleaning method of a film-forming unit according to any of claims 1 to 4, wherein
the nitrogen-including gas is ammonia, dinitrogen monoxide or nitric oxide.

6. A cleaning method of a film-forming unit according to any of claims 1 to 4, wherein
during the purging step, the inside of the reaction chamber is maintained at a range of 133 Pa to 53.3 kPa.

7. A cleaning method of a film-forming unit according to any of claims 1 to 4, wherein
during the purging step, the nitrogen-including gas is supplied into the reaction chamber heated to a predetermined temperature in order to be activated.

8. A cleaning method of a film-forming unit according to claim 7, wherein
during the purging step, the inside of the reaction chamber is heated to a range of 600° C. to 1050° C.

9. A cleaning method of a film-forming unit according to any of claims 1 to 4, wherein
the member in the reaction chamber consists of quartz.

10. A cleaning method of a film-forming unit according to any of claims 1 to 4, wherein
the process gas comprises ammonia and a silicon-including gas,
the thin film is a silicon nitride film, and
the nitrogen-including gas is an ammonia gas.

11. A film-forming method comprising
a cleaning step of cleaning a film-forming unit in accordance with a cleaning method of a film-forming unit according to any of claims 1 to 4, and
a film-forming step of heating the inside of the reaction chamber containing the object to be processed to a predetermined temperature, and forming a thin film on the object to be processed by supplying a process gas into the reaction chamber.

12. A film-forming unit that forms a thin film on an object to be processed by supplying a process gas into a reaction chamber containing the object to be processed, the film-forming unit comprising;
a nitrogen-including-gas supplying unit that supplies into the reaction chamber a nitrogen-including gas that includes nitrogen and that is capable of being activated,
an activating unit that activates the nitrogen-including gas, and
a nitriding unit that nitrides a surface of a member in the reaction chamber by controlling the activating unit so as to activate the nitrogen-including gas.

13. A film-forming unit that forms a thin film on an object to be processed by supplying a process gas into a reaction chamber containing the object to be processed, the film-forming unit comprising;
a nitrogen-including-gas supplying unit that supplies into the reaction chamber a nitrogen-including gas that includes nitrogen and that is capable of being activated,
an activating unit that activates the nitrogen-including gas, and
a contaminant-removal controlling unit that removes metallic contaminant from a member in the reaction chamber by controlling the activating unit so as to activate the nitrogen-including gas and by causing the activated nitrogen-including gas to react with the metallic contaminant contained in the member.

14. A film-forming unit that forms a thin film on an object to be processed by supplying a process gas into a reaction chamber containing the object to be processed, the film-forming unit comprising;
a cleaning-gas supplying unit that supplies into the reaction chamber a cleaning gas that includes fluorine,
a nitrogen-including-gas supplying unit that supplies into the reaction chamber a nitrogen-including gas that includes nitrogen and that is capable of being activated,
an activating unit that activates the nitrogen-including gas, and
a fluorine-removal controlling unit that removes fluorine from a member in the reaction chamber by controlling the activating unit so as to activate the nitrogen-including gas and by causing the activated nitrogen-including gas to react with the fluorine diffused into the member.

15. A film-forming unit that forms a thin film on an object to be processed by supplying a process gas into a reaction chamber containing the object to be processed, the film-forming unit comprising;
a cleaning-gas supplying unit that supplies into the reaction chamber a cleaning gas that includes fluorine,
a nitrogen-including-gas supplying unit that supplies into the reaction chamber a nitrogen-including gas that includes nitrogen and that is capable of being activated,
an activating unit that activates the nitrogen-including gas, and
a nitriding unit that nitrides a surface of a member in the reaction chamber by controlling the activating unit so as to activate the nitrogen-including gas.

16. A film-forming unit according to any of claims 12 to 15, wherein
the nitrogen-including gas is ammonia, dinitrogen monoxide or nitric oxide.

17. A film-forming unit according to any of claims 12 to 15, wherein
the activating unit is a heating unit.

18. A film-forming unit according to any of claims 12 to 15, wherein
the activating unit is a plasma-generating unit.

19. A film-forming unit according to any of claims 12 to 15, wherein
the activating unit is a heating unit that heats the inside of the reaction chamber to a range of 600° C. to 1050° C.

20. A film-forming unit according to any of claims 12 to 15, further comprising
a pressure-adjusting unit that maintains the inside of the reaction chamber at a range of 133 Pa to 53.3 kPa.
